(19) United States
(12) Patent Application Publication
(10) Pub. No.: US 2007/0248802 A1
(43) Pub. Date: Oct. 25, 2007

(54) Laminated Ceramic Component and Method for Manufacturing the Same

(75) Inventors: Ryuichi Saito, Osaka (JP); Hiroshi Kagata, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/574,156

(22) PCT Filed: Sep. 30, 2005
(86) PCT No.: PCT/JP05/18108

§ 371 Date: Feb. 23, 2007

(30) Foreign Application Priority Data
Oct. 8, 2004 (JP) 2004-295921

(51) Int. Cl. B32B 7/02; C03B 29/00

(52) U.S. Cl. 428/213; 156/89.12

(57) ABSTRACT

A laminated ceramic component includes a first laminating sheet, a second laminating sheet, a first electrode pattern and a second electrode pattern. The first and the second electrode patterns are located between the first and the second laminating sheets. The second electrode pattern is wider and thinner than the first electrode pattern.

This application is a U.S. national phase application of PCT International Application PCT/JP2005/018108.

### TECHNICAL FIELD

The present invention relates to a laminated ceramic component having a multi-layer wiring pattern inside the component, and a method for manufacturing the same component.

### BACKGROUND ART

Compact electronic devices including portable phones have required electronic components of lightweight, thin and small in size. For this purpose, an LCR composite circuit board formed of inductor elements, capacitor elements, and resistor elements built therein has been developed. A laminated ceramic component is one of the LCR composite circuit boards. A method of manufacturing a conventional laminated ceramic component is described hereinafter.

A first electrode pattern and a second electrode pattern are placed between a first laminating sheet and a second laminating sheet. The first and second patterns have different electrode widths and are formed simultaneously by screen-printing the same electrode-paste. This kind of laminated ceramic component is disclosed in Unexamined Japanese Patent Publication No. 2001-352271, for example.

As discussed above, the conventional laminated ceramic component is formed by the screen-printing, i.e. the first and the second electrode patterns having different electrode-widths are printed simultaneously by using the same electrode paste on the first and the second laminating sheets. As a result, the first and the second electrode patterns are formed thinly at approx. the same thickness. However, when the first and the second electrode patterns form different types of elements, the same thickness is sometimes undesirable.

For instance, assume that the first electrode pattern forms an inductance element and the second electrode pattern forms a capacitor element. The first electrode pattern is desirably formed of an electrode thick enough for obtaining excellent high-frequency characteristics. On the other hand, the second one is desirably formed of an electrode thin enough for preventing cracks or delamination. However, the conventional method for manufacturing the laminated ceramic component forms the first and the second electrode patterns to be the same thin layers in order to avoid the problems such as cracks caused by the second electrode pattern having a wider width. As a result, the first electrode pattern cannot gain an enough thickness although it needs an electrode thick enough for obtaining the high-frequency characteristics, so that the first electrode pattern as a laminated unit incurs greater power loss.

### DISCLOSURE OF INVENTION

The laminated ceramic component of the present invention has a first laminating sheet, a second laminating sheet, a first electrode pattern, and a second electrode pattern. Both of the first and the second electrode patterns are located between the first and the second laminating sheets. The second electrode pattern is wider and thinner than the first one. These electrode patterns can be formed by controlling the conductive-particle content in the electrode paste used in manufacturing. Since the first electrode pattern is thick enough, power loss as a laminated unit can be prevented. As a result, the laminated ceramic component excellent in high-frequency characteristics is obtainable.

### BRIEF DESCRIPTION OF THE DRAWINGS

FIG. 1 is a sectional view illustrating a structure of a laminated ceramic component in accordance with an embodiment of the present invention.

FIG. 2A is a sectional view showing a manufacturing step in accordance with the embodiment of the present invention.

FIG. 2B is a sectional view showing a manufacturing step following the step shown in FIG. 2A.

FIG. 2C is a sectional view showing a manufacturing step following the step shown in FIG. 2B.

FIG. 2D is a sectional view showing a manufacturing step following the step shown in FIG. 2C.

FIG. 2E is a sectional view showing a manufacturing step following the step shown in FIG. 2D.

FIG. 2F is a sectional view showing a manufacturing step following the step shown in FIG. 2E.

FIG. 2G is a sectional view showing a manufacturing step following the step shown in FIG. 2F.

FIG. 2H is a sectional view showing a manufacturing step following the step shown in FIG. 2G.

FIG. 3A is a sectional view showing another manufacturing step following the step shown in FIG. 2F.

FIG. 3B is a sectional view showing a manufacturing step following the step shown in FIG. 3A.

FIG. 3C is a sectional view showing a manufacturing step following the step shown in FIG. 3B.

FIG. 3D is a sectional view showing a manufacturing step following the step shown in FIG. 3C.

FIG. 4A is a sectional view showing another manufacturing step in accordance with the embodiment of the present invention.

FIG. 4B is a sectional view showing a manufacturing step following the step shown in FIG. 4A.

FIG. 4C is a sectional view showing a manufacturing step following the step shown in FIG. 4B.

FIG. 4D is a sectional view showing a manufacturing step following the step shown in FIG. 4C.

FIG. 4E is a sectional view showing a manufacturing step following the step shown in FIG. 4D.

### DESCRIPTION OF PREFERRED EMBODIMENT

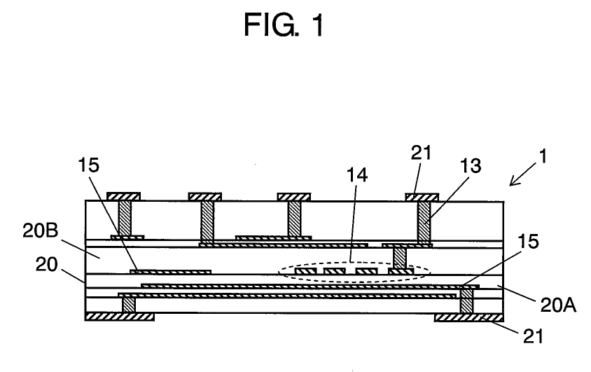

FIG. 1 is a sectional view illustrating a structure of a laminated ceramic component in accordance with an embodiment of the present invention. In laminated ceramic component 1, first electrode pattern (hereinafter referred to simply as pattern) 14 and second electrode pattern (hereinafter referred to simply as pattern) 15 are located between first laminating sheet 20A and second laminating sheet 20B. Patterns 14 and 15 have different electrode widths. To be more specific, pattern 14 is narrower and thicker than pattern 15. In other words, pattern 15 is wider and thinner than pattern 14. That is to say, pattern 14 is either a conductive pattern or an inductor pattern, and pattern 15 is a capacitor pattern. Second laminating sheet 20B is layered over first laminating sheet 20A, and they form a part of laminated ceramic substrate 20. Each of via electrodes 13 couples these electrodes placed inside the layers to each other or couples the inner electrode to surface electrode 21.

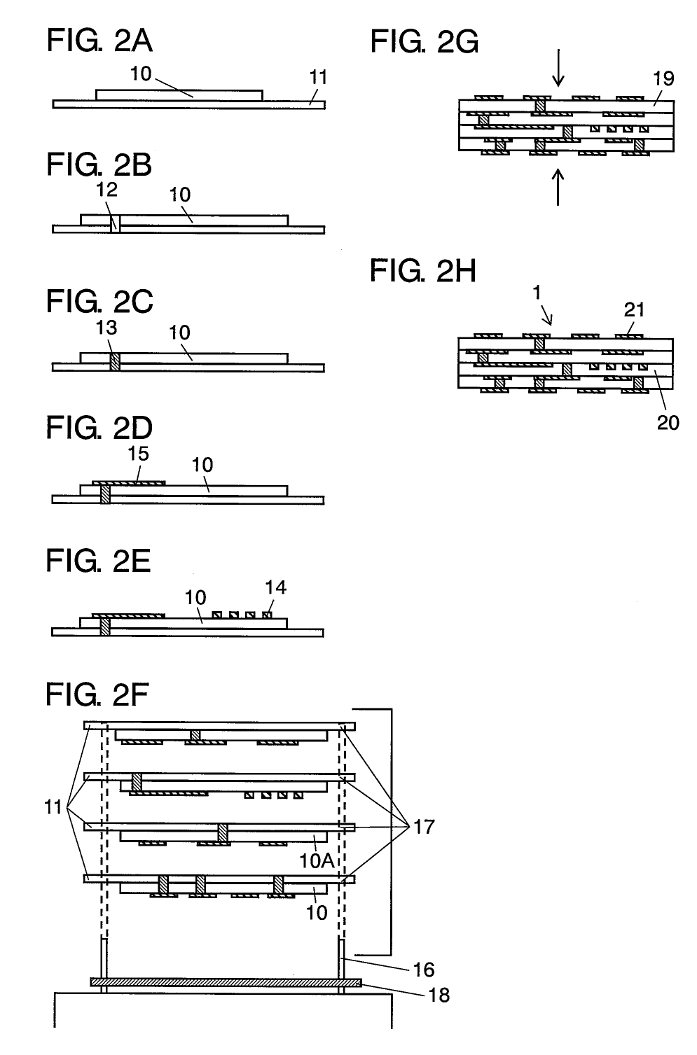

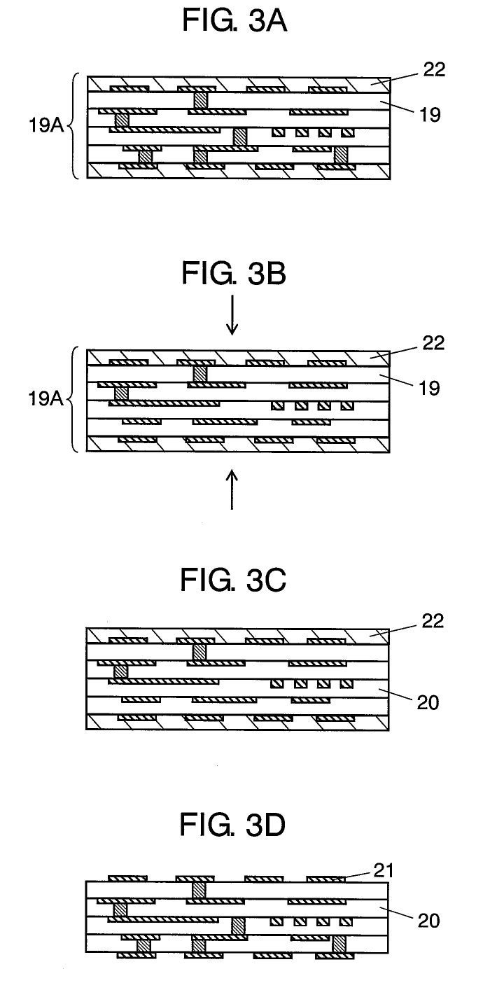

A method of manufacturing the laminated ceramic component discussed above is demonstrated hereinafter. FIG. 2A-FIG. 3D are sectional views illustrating steps of manufacturing the laminated ceramic component in accordance with the embodiment of the present invention.

First, as shown in FIG. 2A, form ceramic green sheet (hereinafter simply referred to as green sheet) 10 as a laminating sheet on base film 11. Green sheet 10 can employ glass ceramic material, which can be sintered at a low temperature. Use of the glass ceramic material as green sheet 10 allows employing the electrode material such as silver (Ag), copper (Cu), or the like having a high conductivity. As a result, a laminated-ceramic component suitable for a compact and sophisticated high-frequency device can be obtained.

Green sheet 10 can be produced in the following manner: First, mix ceramic powder with glass powder to produce glass ceramic material, and then provide this material with polyvinyl-butyral-based resin binder, plasticizer, and organic solvent. Mix and disperse respective components in this mixed body to produce ceramic slurry. For instance Al₂O₃ can be used as the ceramic powder, and alkaline earth silicate glass can be used as the glass powder. These compositions are quoted as an example, and the present invention is not limited to the foregoing compositions.

Form green sheet 10 having a given thickness on base film 11 through the doctor-blade method by using the slurry thus prepared. In this embodiment, a PET film is used as base film 11; however, any film can be used as far as a film has mold releasing characteristics.

Next, as shown in FIG. 2B, form via-hole 12 by punching or laser beam on green sheet 10 which has been cut into pieces of a given size. Upon necessary, form pilot holes 17 shown in FIG. 2F on base film 11 at the same time for laminating the base films. Pilot holes 17 can be formed not only on base film 11 but also on green sheet 10.

Then as shown in FIG. 2C, fill via-hole 12 with via-electrode paste to form via-electrode 13, and print inner electrode patterns by the screen-printing as shown in FIGS. 2D, 2E. Pattern 15 is formed as show in FIG. 2D, and then pattern 14 is formed as shown in FIG. 2E.

When patterns 14 and 15 are screen-printed, it is preferable to use different electrode pastes suitable for respective patterns. To be more specific, first electrode paste which includes Ag powder at the content of 90 wt % is used for pattern 14, and second electrode paste which include Ag powder at 80 wt % is used for pattern 15.

The first electrode paste preferably includes Ag in the range of 85 wt % to 90 wt % (inclusive both the ends), and the second electrode paste preferably include Ag in the range of 70 wt % to 80 wt % (inclusive both the ends). Instead of this change in the content ratio, the first electrode paste can be applied thicker than the second electrode paste; however, the change in the content ratio of Ag allows controlling the thickness of the inner electrode patterns with more ease. Other than the electrode paste of which main ingredient is Ag, the electrode paste including the mixed powder of Ag and palladium (Pd) can be used if the paste can be fired simultaneously with green sheet 10 to be used. Metals other than Ag such as any one of Pd, platinum (Pt), gold (Au), or Cu which has a relatively low conductor resistance can be used, or alloy powder of one of these metals and Ag can be used.

As discussed above, a higher content of Ag powder, which exist as conductive particles in the first electrode paste, than a content of Ag powder in the second electrode paste allows pattern 14 to be formed thicker than pattern 15.

Meanwhile, it is preferable for the first electrode paste to use Ag powder of which average particle diameter is smaller than that of the second electrode paste, so that pattern 14 can be formed more finely than pattern 15 easily and reliably. To be more specific, the average particle diameter of Ag in the first electrode paste is 1 μm, and that of the second electrode paste is 5 μm.

In the case of forming pattern 14 by the screen-printing, a line width can be narrowed as fine as approx. 40 μm. In other words, the screen-printing can form pattern 14 with a line width of 40 μm-80 μm (inclusive both the ends).

It is preferable to form pattern 15 firstly prior to pattern 14 as shown in FIGS. 2D and 2E. Pattern 14 can be formed thicker than pattern 15 formed in advance. This order of forming the electrode patterns allows preventing pattern 14 from being damaged as little as possible.

As discussed above, after forming via-hole 12 and the inner electrode patterns, overlay a plurality of green sheets one after another. At this time, as shown in FIG. 2F, the green sheet with base film 11 facing upward is put on laminating pallet 18. The plurality of green sheets with base films 11 facing upward are indexed at pilot holes 17 provided to films 11 with index pin 16 of a laminating machine. Then overlay green sheet 10 as a first ceramic green sheet onto laminating pallet 18, and peel off base film 11 from the green sheet before overlaying green sheet 10A as a second ceramic green sheet on the face of green sheet 10, on which surface patterns 14 and 15 have been formed. Two green sheets 10, 10A overlaid together undergo a thermo-compression bonding process, and then base film 11 is peeled off. In other words, after the firing, green sheet 10 becomes first laminating sheet 20A, and green sheet 10A becomes second laminating sheet 20B. The foregoing work is repeated until a necessary number of layers is obtained, so that ceramic laminated unit (hereinafter referred to simply as a laminated unit) 19 can be formed as shown in FIG. 2G.

Next, as shown in FIG. 2G, compress laminated unit 19 further more in order to make the density uniform and suppress the delamination between the layers. Finally as shown in FIG. 2H, degrease the compressed laminated ceramic unit at approx. 350-600° C., then fire it at approx. 850-950° C., whereby laminated ceramic substrate 20 having inner electrodes formed of Ag is obtainable. Pattern 14 having undergone the firing has a width of 80 μm, and an electrode thickness of 20 μm. Pattern 15 is 2 mm square and 8 μm thick. When the width of pattern 14 becomes 60 μm, the electrode thickness becomes 15 μm.

Upon necessary, form surface electrodes 21 on laminated ceramic substrate 20. Expected laminated ceramic component 1 is thus obtained. In the case of unitarily manufacturing a plurality of laminated ceramic components 1, dice substrate 20 into pieces of a given size, and mount ICs, surface acoustic wave (SAW) filters, chip components to substrate 20 via surface electrode 21. Instead of this method, these components can be mounted to substrate 20 firstly, and then stuffed substrate 20 can be diced into pieces.

Surface electrode 21 can be fired simultaneously with laminated unit 19, or solely fired after unit 19 is fired. Surface electrode 21 can be fired after dicing the substrate into pieces.

The manufacturing method discussed above can manufacture laminated ceramic components including pattern 14 having an electrode of sufficiently thick and pattern 15 having a rather thin electrode. This structure allows suppressing the power loss of the laminated unit, so that laminated ceramic components 1 excellent in high-frequency characteristics are obtainable.

As shown in FIGS. 3A-3D, a restricting ceramic green sheet (restricting layer) 22 can be used in the thermo-compression bonding process shown in FIG. 2G. This method allows manufacturing a laminated ceramic component more accurate in dimension and excellent in flatness. This method is detailed hereinafter.

First, in the thermo-compression bonding process shown in FIG. 2F, overlay restricting layers 22 on the top face and the underside of laminated ceramic unit 19 shown in FIG. 3A. Restricting layer 22 are a ceramic green sheet made from Al₂O₃, ZrO₂, or MgO and the like, and cannot be sintered at the firing temperature of green sheet 10. Then this layered body undergoes the thermo-compression bonding process, so that laminated body 19A is obtained. Laminated body 19A includes restricting layers 22 on its top face and underside respectively.

Next, compress laminated body 19A furthermore as shown in FIG. 3B. Then degrease and fire laminated body 19A as shown in FIG. 3C, and after the firing, remove restricting layers 22 by grinding, ultrasonic cleaning or blasting as shown in FIG. 3D. Laminated ceramic substrate 20 shown in FIG. 1 and fired at a low temperature and includes electrode patterns is thus obtained.

Even in this case, surface electrode 21 can be provided to laminated ceramic unit 19 in advance for being fired simultaneously with laminated body 19A, or can be formed by the printing after the removal of restricting layer 22, and then can be burned.

Use of restricting layer 22 in the thermo-compression bonding process discussed above allows a laminated ceramic component more accurate in dimension and excellent in flatness to be obtained efficiently.

In the foregoing description, both of patterns 14 and 15 are formed by the screen-printing; however, pattern 15 can be firstly formed by the screen-printing, then pattern 14 can be formed by the intaglio-printing. To be more specific, pattern 14 can be formed through the following way. Fill the intaglio made of resin film with the first electrode paste, then transcribe this electrode paste onto green sheet 10 by thermo-compression bonding. This method is called an intaglio transcription method hereinafter. This method can form pattern 14 more finely than the screen-printing method. In other words, the intaglio transcription method can stably form pattern 14 having a line width not wider than 60 μm that is extremely difficult for the screen-printing method in the current state of the art to form in a mass production level. The intaglio transcription method can form a line as fine as approx. 10 μm wide. That is to say, the intaglio transcription method can form pattern 14 with a line width of 10 μm-60 μm (inclusive both the ends). Next, a method for forming pattern 14 by using the intaglio-printing is demonstrated hereinafter.

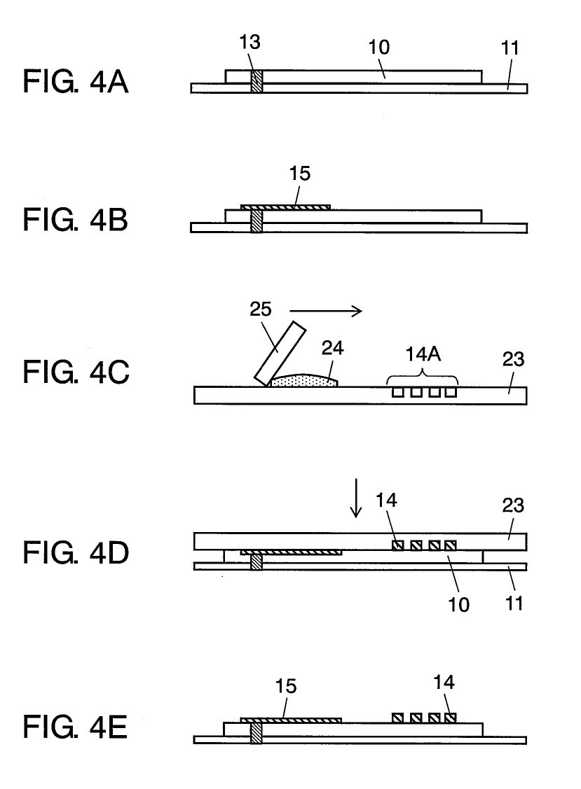

First, after forming via electrode 13 on green sheet 10 as shown in FIG. 4A, form pattern 15 by the screen-printing as shown in FIG. 4B. These steps are similar to those shown in FIGS. 2A and 2B.

Then form pattern 14 as shown in FIGS. 4C and 4D. First, fill intaglio 23 with first electrode paste 24 by using squeegee 25 or the like as shown in FIG. 4C. Intaglio 23 is made of resin film such as polyamide, and has a given recessed pattern 14A formed by a laser beam or the like. Next, transcribe first electrode paste 24 filled in intaglio 23 onto green sheet 10 by the thermo-compression bonding, so that pattern 14 is formed.

The material of the resin film used for intaglio 23 is not limited to polyimide; however, the use of polyimide is preferable in terms of shape stableness and durability. Meanwhile, an easy mold-releasing treatment for the polyimide improves the transcription performance in the thermo-compression bonding process remarkably.

As shown in FIG. 4B-FIG. 4E, it is preferable to form pattern 15 first, then form pattern 14 because of the same reason as described by using FIG. 2D and FIG. 2E. Even in this case, first electrode paste 24 to be used for forming pattern 14 preferably has a higher content of conductive particles than the second electrode paste to be used for forming pattern 15. Furthermore, the average particle diameter of Ag powder to be used as the first electrode paste is preferably smaller than that of Ag powder to be used as the second electrode paste.

The foregoing method can also provide a laminated ceramic component that includes the first and the second electrode patterns between first laminating sheet 20A and second laminating sheet 20B, and these electrode patterns have a different line width and a thickness from each other. In this laminated ceramic component, pattern 14 has the electrode thickness enough even after the firing, and the electrode thickness of pattern 15 is relatively thin. After the firing, pattern 14 has a line width of 60 μm, and thickness of 20 μm, while pattern 15 is 2 mm square and 8 μm thick. When pattern 14 has a line width of 20 μm, the electrode thickness becomes 13 μm.

As discussed above, the use of the intaglio transcription technique in forming pattern 14 allows pattern 14 to have a finer pattern without reducing the thickness extraordinarily than the use of the screen-printing.

The foregoing embodiment proves that the power loss in pattern 14, e.g. a conductive pattern or an inductor patter, can be suppressed, so that the power loss of the laminated unit can be suppressed. As a result, the laminated ceramic component excellent in high-frequency characteristics is obtainable. Since pattern 15 is formed thinly, it hardly incurs cracks or delamination, so that the yield can be improved.

In this embodiment, pattern 14 is either one of a conductive pattern or an inductor pattern, and pattern 15 is a capacitor pattern; however, the present invention is not limited to these examples. The thickness and the line width of those patterns can be controlled in response to the components formed by patterns 14 and 15.

### INDUSTRIAL APPLICABILITY

The method of manufacturing a laminated ceramic component of the present invention allows manufacturing the laminated ceramic component including a first and a second electrode patterns between a first laminating sheet and a second laminating sheet, and these patterns have a different line width and a thickness from each other. After the firing of the component, the first electrode pattern remains thick enough, so that power loss as a laminated unit can be suppressed. The laminated ceramic component excellent in high-frequency characteristics is thus obtainable. Use of this laminated ceramic component allows achieving an electronic device such as a portable phone, which incurs little power loss.

1. A laminated ceramic component comprising:
a first laminating sheet:
a second laminating sheet overlaid on the first laminating sheet;
a first electrode pattern located between the first laminating sheet and the second laminating sheet; and
a second electrode pattern having a greater width and a smaller thickness than the first electrode pattern and located between the first laminating sheet and the second laminating sheet.

2. The laminated ceramic component according to claim 1, wherein the first electrode pattern is one of a conductive pattern and an inductor pattern, and the second electrode pattern is a capacitor pattern.

3. The laminated ceramic component according to claim 1, wherein a line width of the first electrode pattern is at largest 80 μm.

4. The laminated ceramic component according to claim 1, wherein a line width of the first electrode pattern is at largest 60 μm.

5. A method for manufacturing a laminated ceramic component, the method comprising:
(A) printing first electrode paste on a first ceramic green sheet so as to form a first electrode pattern;
(B) printing second electrode paste on the first ceramic green sheet so as to form a second electrode pattern having a greater width and a smaller thickness than the first electrode pattern;
(C) overlaying a second ceramic green sheet on a surface of the first ceramic green sheet so as to produce a laminated unit, the first and the second electrode patterns being formed on the surface; and
(D) firing the laminated unit.

6. The method according to claim 5, wherein the first electrode paste has a higher content of conductive particles than the second electrode paste.

7. The method according to claim 5, wherein an average particle diameter of conductive particles included in the first electrode paste is greater than an average particle diameter of conductive particles included in the second electrode paste.

8. The method according to claim 5, wherein in the step (A) the first electrode pattern is formed by screen-printing, and in the step (B) the second electrode pattern is formed by the screen-printing, and the step (B) is followed by the step (A).

9. The method according to claim 5, wherein in the step (A) the first electrode pattern is formed by intaglio-printing, and in the step (B) the second electrode pattern is formed by screen-printing, and the step (B) is followed by the step (A).
